(19) United States
(12) Patent Application Publication
(10) Pub. No.: US 2023/0120441 A1
(43) Pub. Date: Apr. 20, 2023

(54) SYSTEMS AND METHODS FOR SEQUENCED, MULTIMODAL COMMUNICATION

(71) Applicant: GOATDate LLC, Los Angeles, CA (US)

(72) Inventors: Heather Alexis Hopkins, Los Angeles, CA (US); Jack Clair Hopkins, Lake Forest, CA (US); Michael Roth, Miami Beach, FL (US); Mark Gatto, Beverly Hills, CA (US)

(21) Appl. No.: 17/794,572

(22) PCT Filed: Jan. 21, 2022
(86) PCT No.: PCT/US2021/014439

§ 371 Date: Jul. 21, 2022

Related U.S. Application Data
(60) Provisional application No. 62/965,056, filed on Jan. 23, 2020.

(51) Int. Cl. H04W 4/12; H04L 51/214

(52) U.S. Cl. CPC H04W 4/12; H04L 51/214; H04W 88/06

(57) ABSTRACT

Systems and methods provide multimodal networked communication services. A first user record is identified using an automatically transmitted message from a first user device. Optionally, a verification video is received from the first user device, and a neural network, including a hidden layer, may be utilized to perform identify verification. If verified, the first user is enabled to utilize a mode of communication and/or to a verification indication is provided to other users. In response to receiving a communication request from an application hosted on the first user device, the first user is enabled to communicate with a second user using a first mode of communication for a limited predetermined maximum time length. When the maximum time length has been reached, the communication using the first mode of communication is terminated and the first user is enabled to utilize a second mode of communication to communicate with the second user.

### PRIORITY CLAIM AND INCORPORATION BY REFERENCE

The present application claims priority from PCT Application No PCT/US2021/014439, filed on Jan. 21, 2021, which claims priority to U.S. patent application Ser. No. 62/965,056, filed on Jan. 23, 2020, titled SYSTEMS AND METHODS FOR SEQUENCED, MULTIMODAL COMMUNICATION, the contents of each of these priority applications are hereby incorporated by reference herein in their entirety as if fully set forth herein. The benefit of priority is claimed under the appropriate legal basis including, without limitation, under 35 U.S.C. § 119(e). Any and all applications for which a foreign or domestic priority claim is identified in the Application Data Sheet as filed with the present application are hereby incorporated by reference herein in their entirety and made a part of this specification.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### COPYRIGHT NOTICE

A portion of the disclosure of this patent document contains material which is subject to copyright protection. The copyright owner has no objection to the facsimile reproduction by anyone of the patent document and/or the patent disclosure as it appears in the United States Patent and Trademark Office patent file and/or records, but otherwise reserves all copyrights whatsoever.

### BACKGROUND

### Field of the Disclosure

The present disclosure relates to enabling multimodal communications using different communication content.

### Description of the Related Art

Conventional communication devices enable users to interact via any one of available communication channels, such a voice-only call, video calls, and text messaging. Conventional systems that support more than one communication channel typically do not restrict or control the order of use by a user when communicating with another user.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Some embodiments of a multi-modal communication system disclosed herein include one or more processing devices, a network interface, non-transitory memory that stores instructions that when executed by the one or more processing devices are configured to cause the computer system to perform operations that can include receiving, via the network interface, a message from a first user device automatically transmitted by an application hosted on the first user device, based at least in part on the received message, identifying a record associated with a first user, using the record associated with the first user and records of a first plurality of other users, identifying a subset of users in the first plurality of other users, ranking the subset of users, using the ranking of the subset of users, selecting from the subset of users a second user, selecting a portion of data in a record associated with the second user, wherein the selecting is based at least in part on one or more rules specified by the second user, and/or transmitting the selected portion of data to the application hosted on the first user device, where the application renders some or all of the selected portion of data. Some embodiments of a multi-modal communication system disclosed herein can further include receiving a communication request from the application hosted on the first user device, at least partly in response to receiving the communication request from the application hosted on the first user device, enabling the first user to communicate with the second user using a first mode of communication, wherein the communication using the first mode of communication is limited to a predetermined maximum time length, determining that the predetermined maximum time length has been reached, terminating the communication using the first mode of communication at least partly in response to determining that the predetermined maximum time length has been reached, and after terminating the communication using the first mode of communication, enabling the first user to utilize the second mode of a plurality of modes of communications to communicate with the second user.

Any embodiments of the systems and methods disclosed herein can include, in additional embodiments, one or more of the following features, components, processes, steps, and/or other details, in any combination with any of the other features, components, processes, and/or details of any other embodiments disclosed herein: wherein the operations can further include transmitting a request to a third user device for a verification video, receiving the verification video, analyzing the received verification video, and/or at least partly in response to the analysis of the received verification video, enabling the first mode of the plurality of modes of communications between the third user and another user, wherein at least the second mode of the plurality of modes of communications is disabled; wherein the operations can further include using a neural network that can include an input layer, a plurality of hidden layers and an output layer to detect a first type of speech inflection of a third user in a verification video received from the third user, and/or at least partly in response to detecting a first type of speech inflection of the third user in the verification video received from the third user, inhibiting the third user from accessing one or more services of the multi-modal communication system; wherein the operations can further include receiving a verification video from the first user device, enabling the received verification video to be analyzed, and/or at least partly in response to the analysis of the received verification video, providing a verification indication in association with information regarding the first user to the second user; wherein the operations can further include receiving a verification video from the first user, analyzing the received verification video from the first user to detect a facial image, receiving a still photograph from the first user, the still image including a facial image, detecting the facial image in the still photograph, detecting a facial image in the verification video, using a neural network comprising an input layer, a plurality of hidden layers and an output layer to determine if the facial image in the still photograph is of a same person as the detected facial image in the verification video, and/or at least partly in response to determining that the detected facial image in the still photograph is of a same person as the detected facial image in the verification video, enabling the first user to access one or more services of the multi-modal communication system and/or providing a verification indication regarding the first user to one or more other users; and/or wherein the operations can further include receiving a blocking message with respect to the second user from the application hosted on the first user device, wherein the application hosted on the first user device automatically presents a block control after the communication using the first mode of communication is terminated, and/or at least partly in response from receiving the blocking message with respect to the second user from the application hosted on the first user device, inhibiting the second user from using the first mode communication and the second mode of communication to communicate with the first user.

Any embodiments of the systems and methods disclosed herein can include, in additional embodiments, one or more of the following features, components, processes, steps, and/or other details, in any combination with any of the other features, components, processes, and/or details of any other embodiments disclosed herein: wherein the operations can further include providing images of users in the subset of users to the first user device, wherein a user interface displayed on the first user device enables the first user to swipe through the images using a touch gesture; wherein the operations can further include displaying profile content of users in the subset of users one at a time on the first user device, wherein a user interface displayed on the first user device enables the first user to scroll through the profile content of users; wherein the system can be configured such that a given user in the subset of users is required to input conversation starter questions about the given user into his or her profile content, and/or wherein the conversation starter questions are included in the profile content displayed on the first user device; wherein the first mode of communication can include a video call and conversation starter questions input by the second user are presented on the first user device during the video call; wherein the system can be configured such that the first mode of communication must be completed before any other mode of communication is enabled; wherein the first mode of communication can include a video call and the second mode of communication can include text messaging; and/or wherein the first mode of communication can include a video call and wherein the system can be configured such that the video call must be completed before the second mode of communication is enabled.

Some embodiments of a computer-implemented method disclosed herein can include receiving, at a computer system that can include one or more computing devices, a message from a first user device transmitted by an application hosted on the first user device, based at least in part on the received message, identifying, using the computer system, a record associated with a first user, using the record associated with the first user and records of a first plurality of other users, identifying, using the computer system, a subset of users in the first plurality of other users, selecting, using the computer system, from the subset of users a second user, accessing, using the computer system, a portion of data in a record associated with the second user, transmitting, using the computer system, the accessed portion of data over a network to the application hosted on the first user device, where the application renders some or all of the accessed portion of data, receiving, using the computer system, a communication request from the application hosted on the first user device, at least partly in response to receiving the communication request from the application hosted on the first user device, enabling the first user to communicate with the second user using a first mode of communication, wherein the communication using the first mode of communication is limited to a predetermined maximum time length, and/or determining that the predetermined maximum time length has been reached.

Any embodiments of the systems and methods disclosed herein can include, in additional embodiments, one or more of the following features, components, processes, steps, and/or other details, in any combination with any of the other features, components, processes, and/or details of any other embodiments disclosed herein: wherein the communication using the first mode of communication is terminated at least partly in response to determining that the predetermined maximum time length has been reached and the first user is inhibited from using a second mode of communication to communicate with the second user prior to the communication using the first mode of communication, and after the communication using the first mode of communication is terminated, enabling the first user to utilize the second mode of the plurality of modes of communications to communicate with the second user; wherein the method or operations can further include receiving a verification video from the first user device, enabling the received verification video to be analyzed, and/or at least partly in response to the analysis of the received verification video, providing a verification indication in association with information regarding the first user to the second user; and/or wherein the method or operations can further include receiving a verification video from the first user device, detecting a facial image in the verification video, receiving a still photograph from the first user, the still image including a facial image, detecting the facial image in the still photograph, detecting a facial image in the verification video, using a neural network that can include an input layer, a plurality of hidden layers and an output layer to determine if the facial image in the still photograph is of a same person as the detected facial image in the verification video, and/or at least partly in response to determining that the detected facial image in the still photograph is of a same person as the detected facial image in the verification video, enabling the first user to access one or more services of the multi-modal communication system and/or providing a verification indication regarding the first user to one or more other users.

Any embodiments of the systems and methods disclosed herein can include, in additional embodiments, one or more of the following features, components, processes, steps, and/or other details, in any combination with any of the other features, components, processes, and/or details of any other embodiments disclosed herein: wherein the method or operations can further include receiving a blocking message with respect to the second user from the application hosted on the first user device, wherein the application hosted on the first user device automatically presents a block control after the communication using the first mode of communication is terminated and/or at least partly in response from receiving the blocking message with respect to the second user from the application hosted on the first user device, inhibiting the second user from using the first mode communication and the second mode of communication to communicate with the first user; wherein the operations can further include providing images of users in the subset of users to the first user device; wherein a user interface displayed on the first user device can enable the first user to swipe through the images using a touch gesture; wherein the method or operations can further include providing profile content of users in the subset of users to the first user device, wherein a user interface displayed on the first user device enables the first user to scroll through the profile content of users; wherein the method can further include requiring a given user in the subset of users to input conversation starter questions about the given user into his or her profile content, and wherein the conversation starter questions are included in profile content displayed on the first user device; wherein the first mode of communication can include a video call and conversation starter questions input by the second user are presented on the first user device during the video call; and/or wherein the first mode of communication can include a video call and the second mode of communication can include text messaging.

### BRIEF DESCRIPTION OF THE DRAWINGS

While each of the drawing figures illustrates a particular aspect for purposes of illustrating a clear example, other embodiments may omit, add to, reorder, and/or modify any of the elements shown in the drawing figures. For purposes of illustrating clear examples, one or more figures may be described with reference to one or more other figures, but using the particular arrangement illustrated in the one or more other figures is not required in other embodiments.

FIG. 1 illustrates an example environment.

FIG. 2A illustrates an example of the multi-modal and social networking communication system.

FIG. 2B illustrates an example neural network.

FIG. 3 illustrates an example process.

FIG. 4 illustrates another example process.

FIGS. 5A-5V illustrate example user interfaces.

### DETAILED DESCRIPTION

An aspect of the present disclosure relates to multi-modal communication among disparate, heterogeneous devices (e.g., desktop, laptop, tablet, smart phone, wearable, smart television, game console, etc.), where different modes of communications are performed in a specified sequence according to certain rules. Further aspects relate to systems and methods for user verification. Still additional aspects relate to ensuring that computer resources are not unduly used by stale data and accounts.

Social networking has taken on an ever more central role in enabling people to electronically communicate via networked devices, to discover and meet new people, and to engage in new experiences. However, conventional social networking techniques suffer from several technical drawbacks, including those relating to security, to stale data and stale user profiles, and to inefficiencies in determining to what extent users should engage with each other via networked communication channels, and which networked communication channels should be accessible to users in different contexts.

For example, many online social networking platforms (e.g., dating platforms) have outdated user profiles or profiles of users that are no longer active participants on the social network platform. Still further, certain user profiles contain false information (e.g., facial images, gender, age, interests, location, height, weight, religion, etc.) and are used to create a fictional online persona to fool other users and to lure other users into what would otherwise be unwanted online communications and potentially dangerous in-person meetings. Further, often users establish authentic accounts, but then lose interest or do not actively engage with the system, yet those stale accounts continue to be used by systems in wastefully providing networking recommendations to other users. Yet further, frequently a user will be introduced to another user via an electronic communication channel (e.g., a texting communication channel), agree to meet in person, only to discover that the other user is not a suitable companion.

Multi-modal communication systems and methods are disclosed herein that address some or all of the foregoing drawbacks of conventional social networking communication systems. Although certain examples may be discussed in relation to online dating systems, systems, methods, and techniques described herein are applicable to other networked communication and social networking systems.

As will be described, methods and systems enable verification that an image of a person submitted by a user as allegedly being an image of the user is not simply an image of a different person (e.g., that the user obtained from a website or otherwise). Still further, methods and systems are described to ensure that a user that has an account on a social networking site still intends to be active or if the account is stale and the user is unlikely to be active on the social networking site.

In addition, described herein are methods and systems for multimodal, sequenced communications, wherein users of a social network who want to communicate with each other are required to use a first mode of electronic communication to perform an initial communication, and are then enabled to use a second mode and/or a third mode (or still additional modes) of electronic communication for a subsequent communication.

As will be described, a user may be required to submit a specified number of images of the user to be included in the user's profile and to be later provided for rendering on devices of the other users. Optionally, the user is instructed (via a communication from a multi-modal communication system) that the images of the user may need to meet certain criteria. For example, one image may need to be a frontal image of the user face and the face must occupy a certain percentage (e.g., 75%) of the image frame, a second image may need to be of a profile of the user face, a third image may need to be a frontal image of the user from the knees to the top of the user's head, etc. In addition, the criteria may include a resolution specification (e.g., a minimum of 800×600 pixels, 750×1334 pixels, 640×1136 pixels, 2048×2732 pixels, or 3456×2304 pixels; a maximum of 3000×4000 pixels or 6000×8000 pixels). Other criteria may include color (e.g., must be in black and white or must be in color), required file format (e.g., RAW, JPEG, TIFF, PNG, GIF, etc.), and/or maximum file size (e.g., 5 Mbytes, 10 Mbytes, 29 m Mbytes, etc.).

When an image is received it may be analyzed to determine if it meets the specified criteria. If the image does not meet the criteria, a corresponding notification may be transmitted to the user (e.g., via a user device) identifying the failure, and optionally including a control that enables the user to resubmit an image of the user.

Optionally, the image may also be analyzed to determine if the image is an image of different person (e.g., using deep face verification models, by comparing a fingerprint of the image submitted by the user to fingerprint of images of other people known to be used improperly, etc.).

The user may also be instructed to submit a video (e.g., a file of a recorded video or a live streaming video) of the user reading a script provided by the system. Optionally, the script may be dynamically generated by the system so that each user receives a different script. The script may include the name provided by the user (e.g., “My name is [NAME]”), or other user may simply be instructed to insert the user's name when reading the script (e.g., “My name is [STATE YOUR NAME]”). Optionally instead, a new script is generated periodically (e.g., every hour, every 12 hours, every day, etc.) and users being requested to submit videos during that time period may be requested to read the script for that period.

The script may be configured to be relatively short so as to reduce the amount of network bandwidth needed to transmit the resulting video, the memory needed to store the resulting video, and the amount of processing resources needed to analyze the resulting video. For example, the script may be configured to be read in 2-5 seconds (e.g., typically 3 seconds), 5-15 seconds (e.g., typically in 9 seconds), or 15-30 seconds (e.g., typically 18 seconds).

The submitted videos may then be analyzed, as part of a verification process, to determine if the video includes a video of a person reading the script (which may have been recorded using the front facing camera of the user's mobile smart phone, a laptop or desktop webcam, or using other recording device). For example, a statistical language model (SLM) may be utilized to determine if the correct script is being recited by a person in the video. Advantageously, because the verification process does not need to understand the speaker's intent and only needs to determine if the correct sequence of words is being recited, the verification process does not need to utilize a statistical semantic model (SSM), which require large amounts of processing and memory resources, to determine the speaker's intent. However, optionally an SSM is utilized.

Optionally, the user's inflection may be examined using an artificial intelligence engine (e.g., a deep neural network to perform intonation classification), and if the artificial intelligence determines that the inflection indicates certain undesirable qualities (e.g., hostility, extreme nervousness when repeating the name in the script, etc.), the user may be prevented from establishing an account and/or user system services to communicate with other users.

Optionally, the image of the face of the person in the video is compared with the image of the face in the still image/photograph submitted to be used as the profile image to ensure that the facial image in the video is of the same person as in the still image (e.g., using deep face verification models). If the facial images do not match, optionally the user may be prevented from establishing an account and/or user system services to communicate with other users.

If the user's image meets the image criteria and the user and the user may enabled to use social networking and communication features, examples of which are described herein.

Optionally, the system may be configured so that the foregoing facial image verification is not required or where a user has the option of having facial image verification performed, and users may have their account activated and may be enabled to use social networking and communication features, examples of which are described herein, without such facial image verification. Thus, a user may elect to have the facial image verification process performed, and if the user is successfully verified, a corresponding verification graphic and/or text may be provided on the user's profile or in matches with other users (as described elsewhere herein), potentially making the user more attractive to other users. Optionally, a match filter may be provided via which a user can request to only be shown matches with other users that have been verified using the facial image process, and the matching process will present match results that exclude non-verified users. Optionally, if a user has not been so verified, and shows up as a match with respect to second user, that second user may transmit a message to the user indicating that the second user will not conduct a video communication session until and unless that user has been verified.

Optionally, the user may periodically (e.g., once every six months, once a year, once every two years) be requested to submit a new image of the user and/or a new video of the user reading a new script to ensure that the user is still interested in utilizing the system's services and to obtain an updated image of the user.

The user may be asked to create a user profile, which may include information about the user, and characteristics of other users that the user may be interested in being introduced to via the social networking site. The still and/or video images provided by the user and may be presented to other users as described herein (e.g., in conjunction with a communication request). The profile information and content may be stored in a database record associated with the user's account.

For example, the user's profile record may include some or all of the following information regarding the user: name (real name, online nickname/alias, etc.), phone number (e.g., mobile phone number), email address, age, birth date, zodiac sign, height, color hair, color eyes, gender, religion, other affiliations, lifestyle choices (e.g., alcohol and/or drug use, eating restrictions (e.g., vegan, vegetarian, kosher, halal, etc.), church/temple/mosque going, frequent exerciser, etc.), location (e.g., city, neighborhood, zip code, full address), gender preference for potential matches (men, women, transmen, transwomen, any gender), interests (e.g., movies, genres of movies, music, genres of music, sports, favorite sports teams, art, food, genres of food, travel, travel destinations, books, genres of books, fashion, fitness, technology, etc.), and/or other information.

The user may specify preferences (desirable characteristics) for potential matches, such as age, zodiac sign, gender, religion, other affiliations, lifestyle choices (e.g., alcohol and/or drug use, eating restrictions (e.g., vegan, vegetarian, kosher, halal, etc.), church/temple/mosque going, frequent exerciser, etc.), location (e.g., city, neighborhood, zip code, etc.), gender preference, interests (e.g., movies, genres of movies, music, genres of music, art, food, genres of food, travel, travel destinations, books, genres of books, fashion, fitness, technology, etc.), height, color hair, color eyes, and/or other information.

As will be described, the user's profile, the description of a person that the user wants a potential match to look like, and/or the profiles of other users may be used in selecting potential matches for a the user.

Optionally, in addition to using user profiles in selecting matches to recommend, other factors may be taken into account in generating match recommendations. For example, activity data, such as the number of times a user is selected by other users to engage in online communications with (optionally over a specified period of time), the number of times a user has engaged with another user using a first channel of electronic communication (e.g., video call), which first channel of electronic communication can, (e.g., if the other user has already liked the user), in some but not all embodiments, be required to be used or completed before the user can engage in a second or subsequent channel of electronic communication, the number of times a user has engaged with another user using a second (subsequent) channel of electronic communication (e.g., short messaging service), the number of times a user has engaged with another user using a third channel of electronic communication (e.g., a voice call), the number of times a user goes out on a first date/meeting with another user (optionally over a specified period of time), the number of times a user goes out on a second date/meeting with another user (optionally over a specified period of time), how often the user accesses the matching service (optionally over a specified period of time), and/or other data.

Use of such activity data may greatly reduce the likelihood that a user associated with a stale user account will be recommended as a match to another user, thereby reducing the number of non-productive communication attempts, with a commensurate reduction in the amount of processor, memory, display, and network resources, which would otherwise be used in such non-productive communication attempts.

When a user requests to view potential matches (e.g., by activating a show potential matches control or otherwise), the system may, in real time, filter-out (optionally in the most computer resource efficient manner) the profiles of certain other users that do not meet certain criteria. Such filtering process may greatly reduce the amount of more computer-resource intensive processing needed. Optionally, a request to view potential matches may be automatically transmitted by the application to the system in response to the user accessing a certain user interface (e.g., a potential matches user interface).

The system may first filter out users whose profiles indicate that they are not in an acceptable geographical area (e.g., are outside of the desired location specified by the requesting user), and then filter out users that do not have the desired color hair, age, height, activity data, etc.

The users that match, within a threshold, the requesting user's criteria and optionally, additional criteria of the system (e.g., activity criteria, location criteria if not specified by the requesting user, and/or other criteria), may be ranked and presented to the user in ranked order (e.g., in a list, or one at a time, where the sequence that user images are displayed in accordance with the ranking).

For example, optionally, the ranked results may be presented with a photograph and certain other information (e.g., some or all of the matching user's profile, such as the user's first name, age, general location, and/or one of the topics selected or provided by the requesting user). Optionally, a match score may be generated and presented to the requesting user indicating the closeness of the match. The matching users may be presented in a list, or may be presented one at a time, where the user may indicate an interest in a presented user by activing a corresponding “like” control, or may activate a control indicating a lack of interest (e.g., a dislike control) or, in some embodiments, may provide a swipe gesture, and the next highest ranked matching user may be presented.

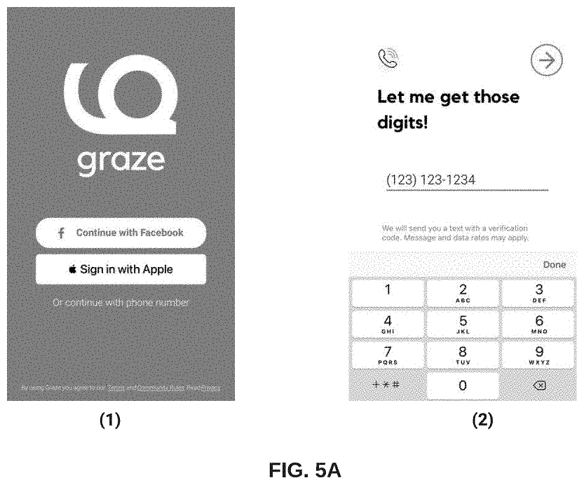

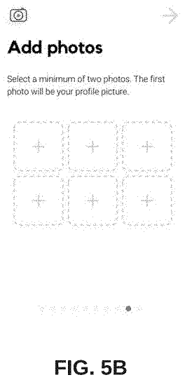

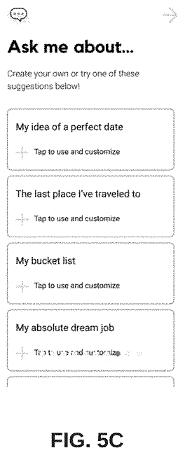

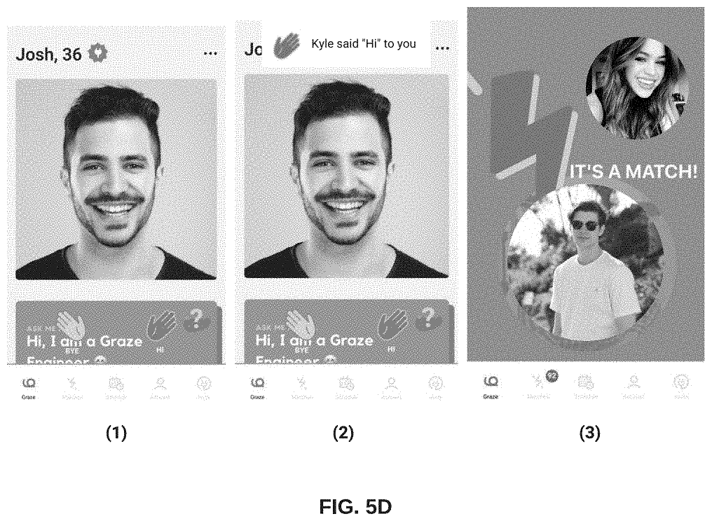

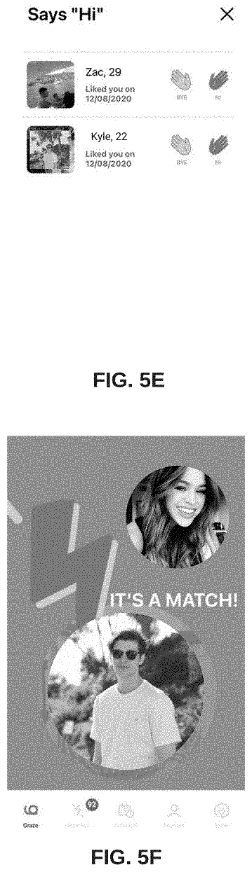

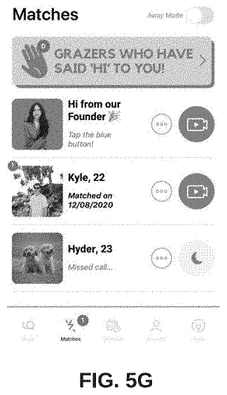

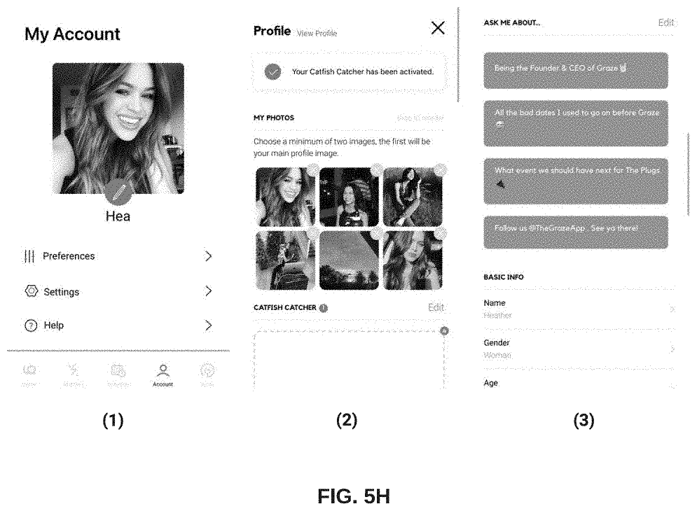

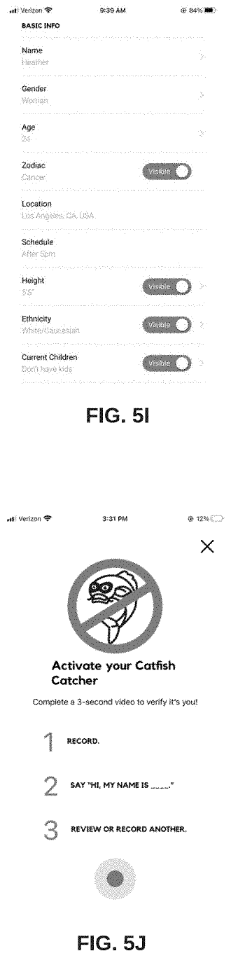

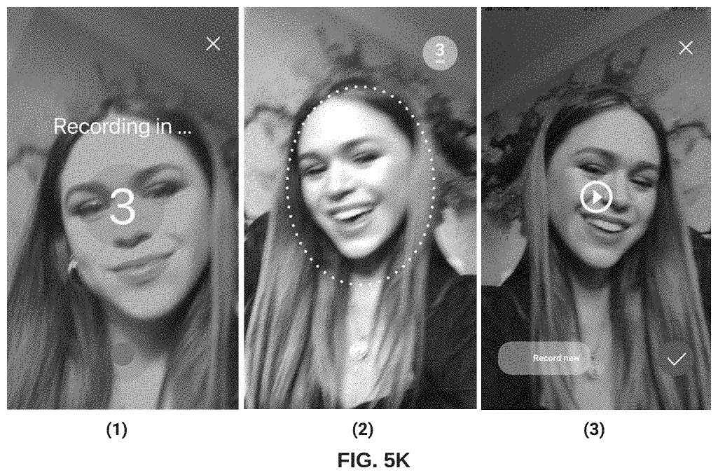

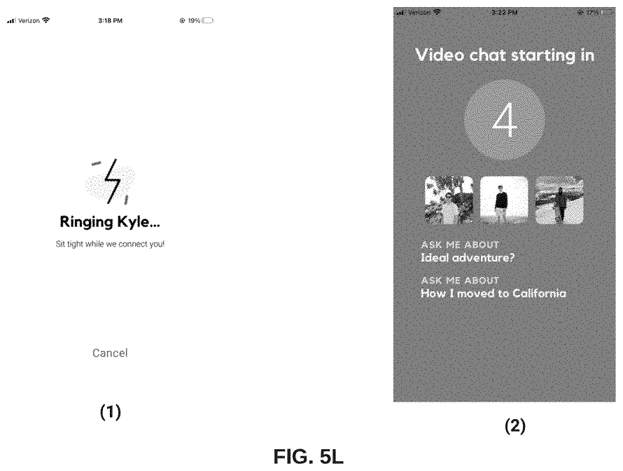

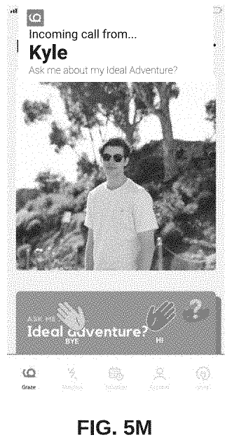

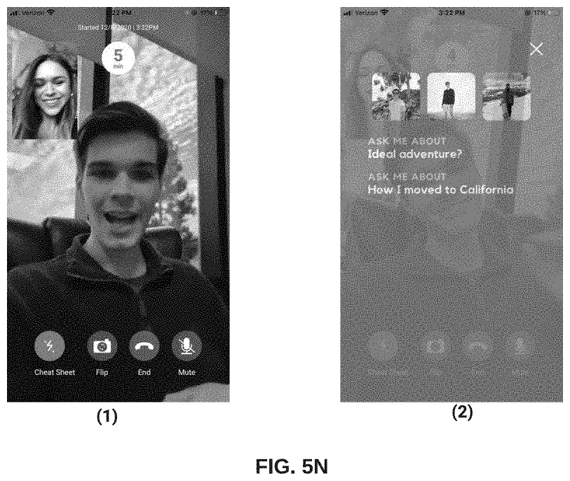

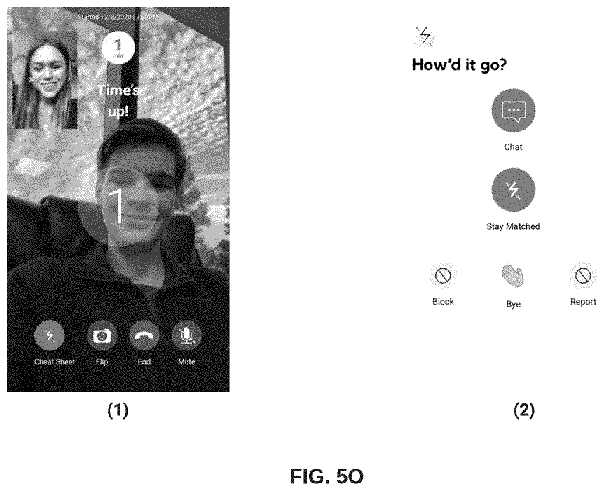

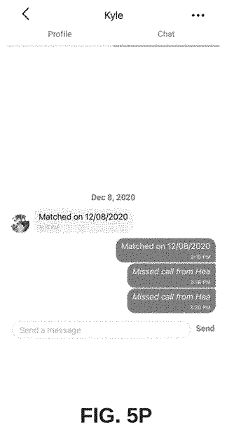

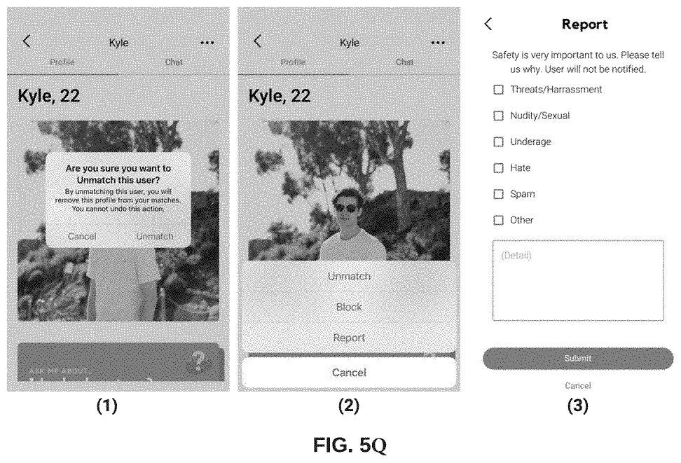

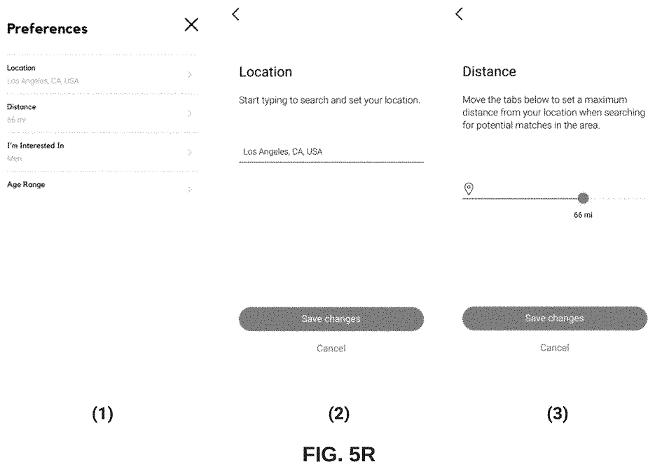

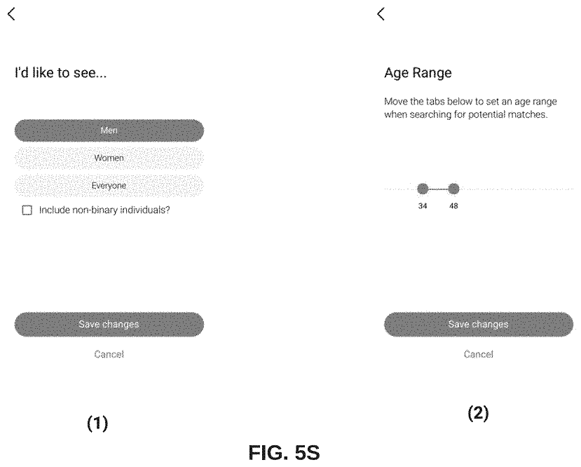

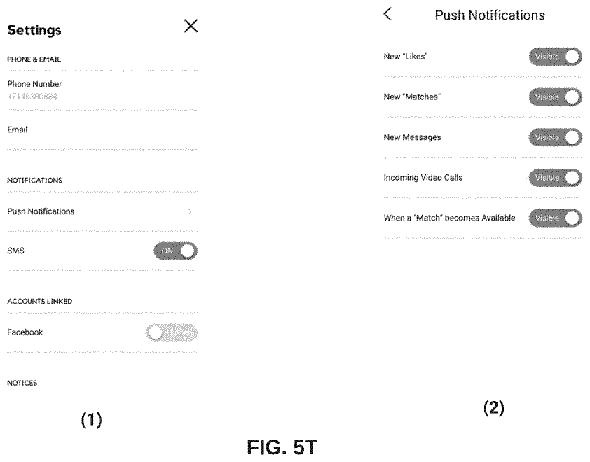

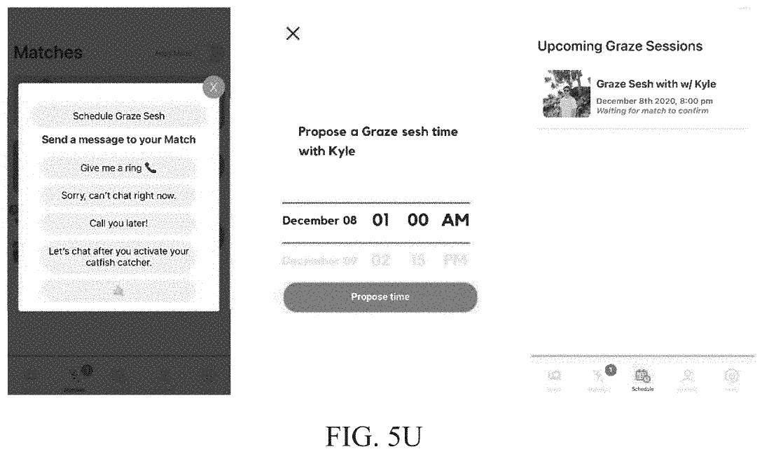

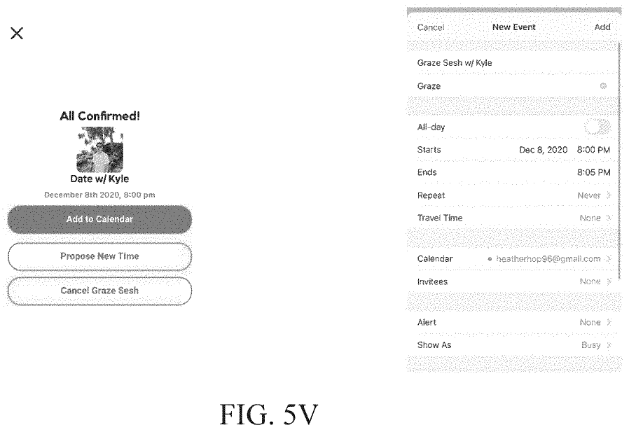

In some embodiments, while a user is viewing a presented user's profile on a browser user interface displaying a potential match, such as in the example shown in FIG. 5D(1) and 5D(2), the user interface enables the user to vertically scroll through the viewed profile content. The viewed profile content can include pictures, ask me abouts, video verification information, characteristics, and/or other information. In some embodiments, the user may be required to decide to not like (e.g., by activating a “Bye” control) the profile or like (e.g., by activating a “Hi” control) the profile. If the presented user is liked, the system can be configured to move the presented user's profile to the “Likes” screen and to present a notification that says, for example and without limitation, “You liked [NAME]”. Optionally, a match may be made and presented via a different user interface (e.g., a “Grazing” or browsing section).

The system can then be configured to display the next presented user's profile. Some embodiments of the system can be configured such that there are no functions performed by swiping while reviewing presented user's profiles. In some embodiments and without limitation, where the user is presented with one presented user or match at a time, the user may be required to view all of the information regarding a presented user or may be required to scroll through all of the information regarding a presented user in order to indicate an interest in the presented user, and/or before seeing any information or images regarding a different match or presented user. Thus, optionally, the user's navigation of interface displaying the information regarding a presented user may be monitored to determine whether the user has scrolled through all (or a specified subset) of the present information.

If the user selects (by indicating an interest in) one of the proposed matches, the selected proposed match may be notified of the expressed interest (e.g., via an application stored on the selected user's device, a short messaging service (SMS) message, an email, a voice notification, a web application, and/or otherwise). The notification may optionally be presented in association with the image (an image including the user's face, torso, and/or legs) and certain profile information of the requesting user (e.g., name, age, selected topics, etc.). The selected user may indicate an interest or lack of interest in the requesting user via corresponding user interface controls. If the selected user indicates an interest in the requesting user, a first communication may be initiated via a first communication channel (e.g., a video communication channel), where the users may be inhibited from communicating via other system communication channels until they have completed the first communication using the first communication channel. In other words, though not required, any embodiments herein may be configured such that a user or users are required to complete a first communication channel before the user or users are permitted to use or engage in a second or subsequent communication channel.

Optionally, a scheduling user interface may be provided via which users can schedule a date and time for the first video chat communication. Optionally, a calendar entry may be added to a calendar (e.g., a calendar hosted by the system and/or a third party calendaring system). Optionally, one or more reminders may be provided to both users participating in the first video chat communication (e.g., a specified period prior to the scheduled chat, via one or more communication channels, such as a sound generated via a user device, a pop-up displayed reminder, a text message sent to a user phone/text messaging device, or otherwise).

The first communication may be limited to a first maximum time period (e.g., five minutes) to provide sufficient time for the users to get to know one another and to decide whether further interaction is desirable, while avoiding uncomfortable non-productive conversation and while reducing the amount of computer and network resources being used.

Just prior to or during the initial conversation, one of the user's may be prompted to ask the other user regarding a topic previously selected by the other user (e.g., “Ask me about my dog Spot!”). Optionally, if one user specified several topics, all of the topics may be presented to the other user, and the other user may choose which topic is to be used in initiating a conversion (or to be used during the conversation).

Once a first mode of communicating (e.g., a video call or other mode of communicating), which may be required to be completed before a user is permitted to initiate a second or subsequent mode of communicating is completed (e.g., as determined based on a detection that the maximum time period expired or that one of the users terminated the first mode of communicating), each participating user may be prompted via a user interface to select among several options. For example, a user may be provided with the option to continue communicating with the other user using the first mode of communication, a second mode of communication (e.g., text message), and/or a third mode of communication (e.g., a voice-only call). Each user may also be provided with an option to continue browsing through other images and/or other information of other users via a corresponding user interface presenting match recommendations (e.g., the previously generated recommendations, or a new set of recommended matches). In addition, a user may be provided with an interface via which the user can block future communications from the other user, unmatch the other user (so that the other user is excluded from future match recommendations provided to the user), or via which the user may report the other user for inappropriate language, inappropriate conversation (e.g., hate speech), or actions taken during the conversation. The system may receive and store the option(s) selected by the user and take appropriate action.

Certain aspects will now be described with reference to the figures.

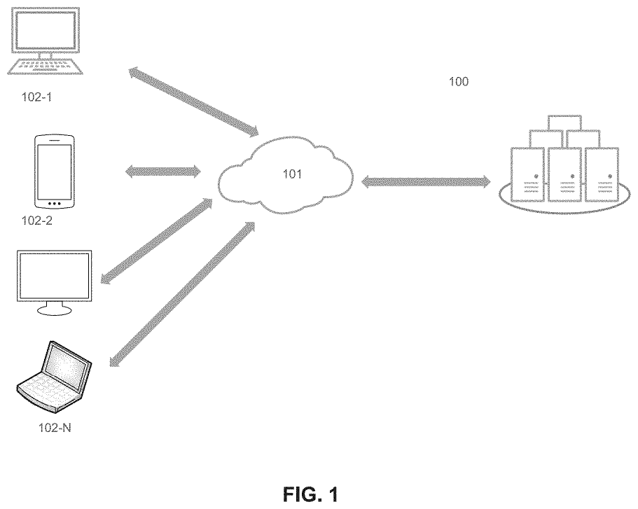

Referring to FIG. 1, an example multi-modal and social networking communication system 100 may communicate over a network 101 with a plurality of user systems 102-1 . . . 102-N. Optionally, the multi-modal and social networking communication system 100 may interact with the user systems via a client server configuration (e.g., via a web service).

Optionally, the user systems 102-1 . . . 102-N may have a dedicated software application installed therein (e.g., a dating “app”) which may be used to communicate with the multi-modal and social networking communication system 100, to provide images (e.g., still photographs and/or video images), and to communicate with other user systems using one or more communication channels (e.g. A video communication channel (which includes voice communication), a text/graphic communication channel (e.g., SMS/MMS communication channel), or a voice-only communication channel).

The app may have been downloaded to the user systems 102 over a wireless network from an app store or may have been preinstalled on the user systems 102. The app may be used to provide and access content and data from the system 100. In addition, the app may be configured to enable a user to communicate with other users (e.g., via video/audio, audio only, or text) for the purpose of creating relationships as discussed herein. The app may also provide user interfaces via which the user may provide profile data, some of which may be shared with other app users as described herein.

The multi-modal and social networking communication system 100 may comprise a hosted computing environment that includes a collection of physical computing resources that may be remotely accessible and may be rapidly provisioned as needed (sometimes referred to as a “cloud” computing environment). The multi-modal and social networking communication system 100 may also include a data store. The data store is optionally a hosted storage environment that includes a collection of physical data storage devices that may be remotely accessible and may be rapidly provisioned as needed (sometimes referred to as “cloud” storage).

The plurality of user systems 102-1 . . . 102-N may include standalone computers (e.g., desktop, laptop, tablet, smart phone, wearable, smart television, game console, or other computer device), a centralized computer system, or a cloud computing system. The user systems 102-1 . . . 102-N may be associated with users that are seeking potential dates or other social networking contacts.

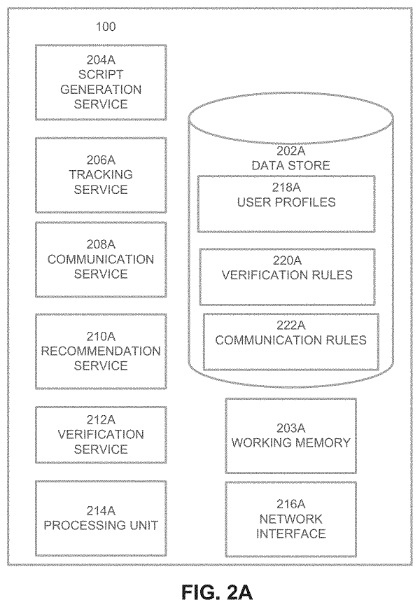

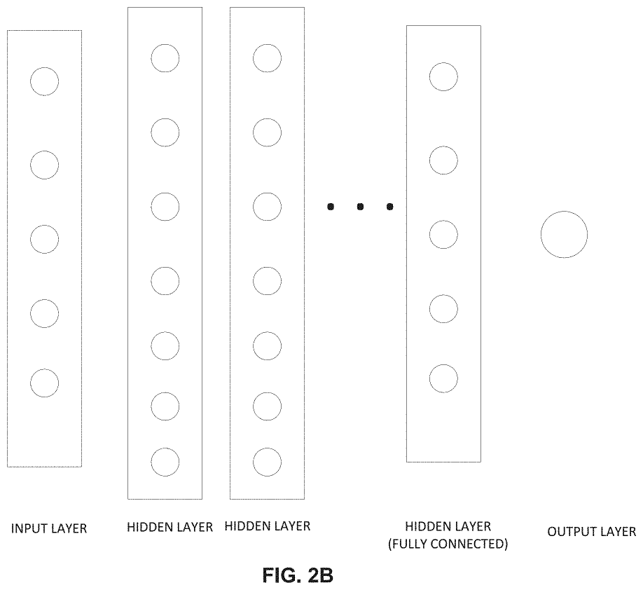

FIG. 2A illustrates an example of the multi-modal and social networking communication system 100. The example system 100 may include one or more processing units 214A (e.g., central processing units) configured to execute programs (e.g., stored in memory). Memory 203A may be used as working memory to store dynamic data created during execution of programs. The system 100 may include one or more network interfaces 216A which enables the system to communicate with user device 102 and/or other networked systems.

The system 100 may provide a variety of optional services, such as a script generation service 204A, used to dynamically generate scripts for users to read as part of a verification process. For example, the script for a given user may be dynamically generated to include a user's name, random phrases, news which occurred on the day the script was generated, a current date and/or time, or the like. Optionally, the script generation service 204A may generate a unique script for each user, set of users, and/or for different time periods (e.g., different minutes, hours, dates, etc.). The number of words of a generated script may be limited to no fewer than a first threshold number of words and no more than a second threshold of words (e.g., to ensure that the speaking time is long enough to perform a verification process and not longer than needed so as to avoid unduly utilizing system resources). Optionally instead, a script may be fixed and used by different users at different times. As described elsewhere herein, a user attempting to establish an account or use certain system 100 services, may be required to record a video/audio of the user reading the script.

A verification service 212A may analyze video recordings (which may be lived streamed or may be files of recorded video) received from user devices 102 to ensure that the recording complies with verification rules 220A accessed from a data store 202A (which may comprise volatile or non-volatile memory, and where some or all of the data stored therein may be in the form of an SQL or noSQL database). For example, a verification rule may specify that the recording needs to be a minimum and/or maximum time length. By way of further example, a verification rule may specify that the face needs to fill a minimum percentage of a frame of the video (e.g., 35%, 50%, 75%, etc.). By way of yet further example, a verification rule may specify that the face in the video must match a face in a still image submitted by the user (e.g., a photograph to be used as a profile photo). For example, the verification service 212A may include a deep neural network trained to identify matching faces.

Optionally, different nodal points on a human face identified in the video may normalized, and the distance between nodal points many be measured. Similarly, different nodal points on a human face identified in the still image may normalized, and the distance between nodal points many be measured. The nodal distances from the video and the still image may be compared, and a determination may be made whether there is a match (e.g., the distances are within a specified threshold of each other). If there is a match, this portion of the verification process may be satisfied. If there is not a match, this portion of the verification process may have failed, and the user may be inhibited from creating an account on the system 100 and/or utilizing certain system 100 resources.

A recommendation service 210A may access, in response to a user request for match recommendations, the profile (including preferences) 218A of the requesting user and profiles (including preferences) of other users 218A from the data store 202A. In addition, the recommendation service 210A may access user activity data. The recommendation service 210A may utilize the profile data, activity data, and/or other data to generate match recommendations for the requesting user.

A communication service 208A may be utilized to initiate and manage communications between users (e.g., in response to users indicating a desire to communicate with each other). The communication service 208A may access communication rules 222A which may specify what communication channels may be used to by users to communicate with each, the sequence in which such communication channels are to be used, and a maximum time length (if any) that a given communication channel may be used by a user for a given communication session.

A tracking service 206A may be utilized to monitor user communication frequency, dates/times of user communication, in-person meetings between users, and/or other activities to generate activity data used by the recommendation service in making recommendations.

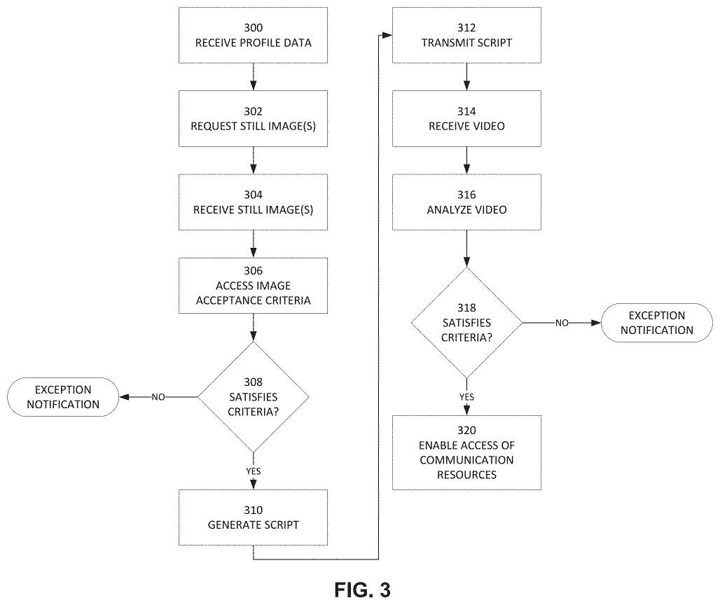

Referring to FIG. 3, an example image analysis and verification process. As discussed above, such facial image analysis and verification process may be optionally performed. For example, a recommendation may be provided to a user to have the facial image verification process be performed, but the user may decline such recommendation and still be enabled to utilize services described herein without such verification. At block 300, user data is received at a multi-modal and social networking communication system over a network from a user device which may be used to populate a profile for the user. For example, a user name, email address, mobile phone number (short messaging service address), street address, city, state and/or zip code may be received and stored. The profile data may have been entered by the user or by the user device into user interface fields provided by an app downloaded to and installed on the user device. Optionally instead, the profile data is received via fields in a web page hosted by the multi-modal and social networking communication system. It is understood that the user interfaces described herein may be provided via an app or via a web page served to a user device.

At block 302, the user is requested to provide one or more digital still photographs of the user. The request may specify certain criteria the photograph(s) need to meet, such as minimum resolution/size, maximum resolution/size, minimum percentage of the photograph that the user's face needs to occupy, file type (e.g., RAW, JPEG, TIFF, PNG, GIF, etc.), color criteria (e.g., black and white or color), and/or the number of photographs that need to be submitted.

At block 304, one or more photographs are received over a network at the system from the user device. At block 306, the system accesses the still image acceptance criteria. At block 308, the photograph(s) are analyzed to determine if they meet the accessed acceptance criteria. For example, if the photograph is not the correct file type, a corresponding criteria failure indication may be recorded.

By way of further example, a face detection algorithm may utilize a trained classifier that decides whether an image contains a face or does not contain a face. For example, a Haar classifier or a Local Binary Pattern (LBP) classifier may be utilized. By way of further illustration, deep learning techniques using a Multi-task Cascade Convolutional Neural Network (MTCNN) may be utilized. In addition to identifying the presence of a face, the process may localize the face to identify the face boundaries. If a face is not detected, a corresponding criteria failure indication may be recorded.

Once the face boundaries are determined, the ratio of the face area versus the total photograph frame area may be determined, and the ratio may be compared to the minimum percentage face/image criteria to determine if the criteria is satisfied. If the percentage criteria is not met, a corresponding criteria failure indication may be recorded.

The photograph(s) may be further analyzed to determine if other criteria are met.

At block 308, a determination is made, identifying any criteria failure indications as to whether the photograph(s) have satisfied corresponding criteria. If the photograph(s) have failed to satisfy corresponding criteria, a corresponding notification may be generated identifying the failure and the reasons for the failure, and the notification may be transmitted to the user device. The notification may include a control, that when activated, enables the user to submit a different photograph to attempt to meet the acceptance criteria.

If the photograph(s) satisfy the acceptance criteria, at block 310 a text script is optionally generated for the user speak and record in a video recording. (although optionally the script may have been generated earlier). Optionally, the text script may be generated based at least in part on the received profile information. For example, the script may include the name provided by the user (e.g., “My name is [name from user profile]”). The script may be configured with a certain number of words so that it should take no more than a first time threshold to read, and no less than a second time threshold to read (e.g., 2-7 seconds).

At block 312, the script may be transmitted to the user device (e.g., the app hosted on the user device) in association with instructions for the user to read the script with making a corresponding video recording. Optionally, the script and instructions are provided to the user only after the user has indicated that the user would like to communicate with another user (e.g., a recommended matching user), as described elsewhere herein. At block 314, the video recording is received from the user device (e.g., the app hosted on the user device) at the system (e.g., as a single file, via real time streaming, or otherwise).

At block 316, the video recording may be analyzed (optionally in real time) with reference to video recording acceptance criteria (e.g., face in video recording needs to match face in profile photograph, video recording needs to be in certain file format (e.g., AVI (Audio Video Interleave) FLV (Flash Video Format) WMV (Windows Media Video) MOV (Apple QuickTime Movie) MP4 (Moving Pictures Expert Group 4) formats), face needs to occupy a percentage of same or all of the video frames, etc.).

By way of example, the process may compare the face in the video recording with the face in one or more of the still photographs provided for the user profile and determine if the faces match (are of the same person). For example, a face may be detected and localized in a video frame, facial landmarks may be detected (e.g., eyes, nose, mouth), the face may be aligned (as may be the face in the still photograph), the pixel values of the face image in the video frame and the face image in the still photograph may be transformed into compact and discriminative feature vectors (sometimes referred to as a template), and at block 318 the still photograph and video templates may be compared to produce a similarity score that indicates the likelihood that the still photograph template and the video template belong to the same subject. Optionally, a trained neural network may be utilized to determine if the face in the video and the face in a still photograph are the same face.

For example, by way of illustration, a deep neural network, such as that illustrated in FIG. 2B, may utilize an autoencoder architecture (including an encoder and a decoder). The CNN may include an input layer, one or more hidden layers, and an output layer. The neural network may be configured as a feed forward network. The neural network may be configured with a shared-weights architecture and with translation invariance characteristics. The hidden layers may be configured as convolutional layers (comprising neurons/nodes), pooling layers, fully connected layers and/or normalization layers. For example, there may be 5 to 10 convolutional layers, the last 1-3 of which are fully connected.

The convolutional deep neural network may be configured with pooling layers that combine outputs of neuron clusters at one layer into a single neuron in the next layer. Max pooling and/or average pooling may be utilized. Max pooling may utilize the maximum value from each of a cluster of neurons at the prior layer. Average pooling may utilize the average value from each of a cluster of neurons at the prior layer.

The neural network may be trained using a triplet loss function. For example, the neural network may be trained using a large set image triplets, where one image is the anchor facial image, and where the neural network is to determine which face in the other two images is more similar to the face in the anchor image. Prior to training the neural network, a large number of humans may have analyzed the triplets and identified which face is closer to the anchor facial image. The image with the closer matching face may be termed the positive image and the other image may be termed the negative image.

The triplet loss function may attempt to learn an embedding in which the anchor images are closer to the positive images. For example, a given node edge may be assigned a respective set of weights. Backpropagation may be used to adjust the weights each time the triplet error is calculated to improve the autoencoder performance.

If the video failed to satisfy corresponding video acceptance criteria, a corresponding notification may be generated identifying the failure and the reasons for the failure, and the notification may be transmitted to the user device. The notification may include a control, that when activated, enables the user to submit a different video to attempt to meet the video acceptance criteria.

If the video satisfies the acceptance criteria, at block 320, the user's account may be activated and/or the user may utilize system match and communication services (e.g., video/voice, text, etc.) to meet and communicate with other system users.

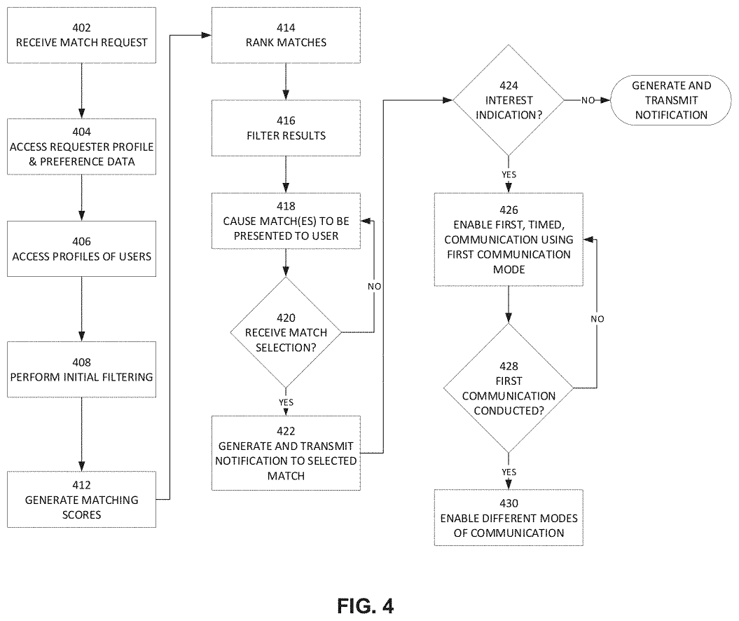

FIG. 4 illustrates an example matching and multi-modal communication process. At block 402, a match request is received from a user device (e.g., indicating that a user (referred to as a requesting user) wants to be matched with a suitable other user. The match request may be issued in response to the user opening a corresponding app downloaded to the user device or in response to the user affirmatively activating a match request control. The request may be received in association with a user identifier (which may be in the form of a user ID, password, a unique identifier associated with the instantiation of the app installed on the user device, biometric data, and/or the like, which may be transmitted by the app).

Optionally, the user verification process discussed above with reference to FIG. 3 may be performed, where a script may be generated and provided to the requesting user, and where the requesting user provides a video that is supposed to include a file or live stream recording of the requesting user reading the script, which may be verified in real time. Optionally, the verification process may be conducted each time the user accesses the app and initiates a match request and/or each time the requesting user wants to initiate an initial communication (e.g., a video call) with a matched user.

At block 404, the user identifier may be utilized to locate a corresponding user profile. The user profile may include one or more images of the requesting user face, the user's name, phone number (e.g., mobile phone number), email address, age, birth date, zodiac sign, height, color hair, color eyes, gender, religion, other affiliations, lifestyle choices (e.g., alcohol and/or drug use, eating restrictions (e.g., vegan, vegetarian, kosher, halal, etc.) church/temple/mosque going, frequent exerciser, etc.), location (e.g., city, neighborhood, zip code, full address), gender preference for potential matches (men, women, transmen, transwomen, any gender), interests (e.g., movies, genres of movies, music, genres of music, sports, favorite sports teams, art, food, genres of food, travel, travel destinations, books, genres of books, fashion, fitness, technology, etc.), and/or other information.

In addition, user match preference information may be accessed for potential matches, such as age, zodiac sign, gender, religion, other affiliations, lifestyle choices, location, gender preference, interests, height, color hair, color eyes, and/or other information.

Appearance preferences of the requesting user may be in the form of textual descriptions that the user wants a potential match to look like.

At block 406, the profiles of other users may be accessed. At block 408, the profiles of other users may be initially filtered using criteria that may permit such filtering to be performed relatively quickly while using relatively lower amounts of computer resources (e.g., processing and memory resources) as compared to performing more complex matching functions. For example, user profiles whose zip codes indicate that they are out of the desired location may be filtered out. By way of further example, user profiles that indicate that the user is not of the desired gender may be filtered out. By way of yet further example, user profiles that indicate that the user is not of the desired age range may be filtered out

At block 412, a match score may be generated for each potential match based on the requesting user's profile and preferences, the potential matching users' profile, and other criteria, such as activity criteria.

At block 414, the potential matching users' may be ranked based on their respective match scores. At block 416, those potential matching users' having a score below a match threshold value may be filtered out. Optionally instead, a predetermined number of matching potential users may be retained (e.g., the top ten), and the other matching potential users may be filtered out.

At block 418, profile data of the remaining potential matching users (e.g., age, photograph(s), video, name, conversation starters, etc.) may be transmitted to the requesting user's device. For example, the images of the remaining potential matching users may be displayed one at a time on the requesting user's device, where the requesting user may indicate an interest in a given potential matching user or navigate to a next potential matching user image (e.g., using a swipe function using a finger when the user device has a touch display). Optionally, multiple potential matching users may be presented at the same time (e.g., in a recommendation list that includes images of the potential matches, with like and not interested controls).

At block 420, a determination is made as to whether the requesting user has indicated an interest in a potential match (e.g., by activating a corresponding interest “like” control). If the requesting user has indicated an interest in a potential match, at block 422, a notification may be transmitted to a destination associated with the potential match (who may be referred to as a recipient user).

For example, the notification to the potential match may be presented via an app installed on the recipient user's device, via a short messaging service, via an email, via a voice notification, and/or otherwise. The notification may be included in a user interface (e.g., a match inbox) provided by the app that displays a list of users that liked the recipient user, wherein a given user entry include a like and a not interested control. The list may be dynamically updated to remove entries of users that the recipient user has provided a not interested indication (or that the recipient user has blocked, unmatched, or reported as discussed elsewhere herein).

The notification to the recipient user may include a profile image of the requesting user, and some or all of the requesting user's profile (e.g., name or portion thereof, interests, life style, height, “ask me about” topic(s), etc.). The recipient user may indicate a reciprocal interest (e.g., by activating a like control displayed in association with the requesting user's image). The like indication may be transmitted by the app or otherwise to the system, and the system will mark the requesting user and the recipient as a match. Alternatively, the recipient user may activate a control indicating a lack of interest which may likewise be transmitted to the system, and the notification may be removed from the recipient user's match inbox. Optionally, he recipient may take no action, and the notification may remain in the recipient's match inbox.

If, at block 424, a determination is made that the recipient provided a reciprocal interest indication, optionally the user verification process discussed above with reference to FIG. 3 may be performed, where a script may be generated and provided to the recipient user, and where the recipient user provides a video that is supposed to include a file or live stream recording of the recipient user reading the script, which may be verified in real time. If the verification process fails, the recipient user may be inhibited from interacting with the requesting user via the system.

Otherwise, at block 426, a timed first mode of communication may be enabled to enable the requesting user and the recipient user to communicate (e.g., to determine if they are interested in going on a date). For example, the first mode of communication may be a video call communication. In some embodiments, though not required, the first mode of communication is a video call communication, which may be required to be completed before other modes of communication are permitted or accessible by the user, as mentioned above. A quick message user interface may be provided comprising a preset menu of messages from which a user may select and transmit to the other user. Optionally, a user interface may be provided enabling a user to transmit scheduling data for the first video communication session/date (e.g., a video chat invite including a date and time). Optionally, the user may be inhibited from sending a free form, custom message to the other user prior to the first video call. Optionally, the communication may be initiated immediately, within a specified time frame (e.g., a one day or one week period starting immediately), or at any time.

The video call communication duration may be limited to a specific period of time (e.g., 2 minutes, 5 minutes, 15 minutes, or other time period). Optionally, a countdown timer may be displayed via both the requesting user's device and the recipient user's device (e.g., via respective apps or browsers) in association with the video call interface (e.g., overlaying the video display area or adjacent thereto). Once the time expires, the video call channel may be automatically terminated. Optionally, a textual and/or graphic message may be displayed and/or a sound generated via both devices notifying the requesting user and the recipient of the termination and of options to continue interactions via one or more specified communication channels.

At block 428, a determination may be made as to whether the requesting user and the recipient user have conducted a communication using the first channel (e.g., the video call channel). If the determination indicates that the requesting user and the recipient user have conducted a communication using the first channel, the process may proceed to block 430, and additional modes/channels of communication may be made available to both the requesting user and the recipient user via which the two may continue communicating.

Optionally, controls may be provided via which the requesting user and the recipient may initiate communications via a selected communication channel (e.g., text, video/audio, audio only, etc.). For example, the requesting user and the recipient may utilize a selected communication channel (or the original video channel) to schedule an in-person meeting (e.g., a date).

Optionally, controls may be provided that enable one user to block the other user (so that the blocked user will not be able to further communicate with the blocking user, and/or so that the blocking user will not be suggested as a match to the blocked user in the future and so that the blocked user will not be suggested as a match for the blocking user in the future), that enable a user continue browsing through potential match recommendations, and/or that enable a user to submit feedback regarding the other user (e.g., an identification of unsatisfactory/offensive speech or behavior, a rating of the communication experience on a scale of 1 to 5, a textual description, a score, etc.).

Optionally, user selections of recommended matches may be used to further train the matching engine (e.g., a deep convolutional neural network). Optionally, different matching engine configurations may be utilized for different users based on corresponding user selections of recommended matches.

Certain example user interfaces will now be discussed with reference to the figures. Certain example user interfaces may be optimized for a relatively small touch display, such as a mobile phone display. Such user interfaces may be optimized to reduce the amount of navigation needed within or between interfaces and certain controls may be sized so as to be easily activated using a finger, while not utilizing an undue amount of display real estate. Certain user interfaces may be presented via a dedicated social networking application (e.g., a dating application).

Referring to FIG. 5A(1), an example user interface is illustrated that enables an account to be created. A control to access an existing social network account is provided that enables a user to access the dedicated application (e.g., a dating application) by connecting an existing social network account of the user (on a different social networking platform) and the credentials of the existing social network account. In addition or instead, a control may be provided enabling the user to initiate establishment of an account using a mobile phone number of the user. In addition, acceptance controls may be provided via which the user needs to agree to usage terms and conditions before an account is established.

If the user accesses the mobile phone number control, the example user interface illustrated in FIG. 5A(2) may be presented. A field is configured to receive the user's mobile number. A touch numeric keyboard is provided via which the user may enter the mobile phone number, which will appear in the mobile phone number field.

A verification text message may be sent to the entered phone number. The recipient of the text message may need to send a response text message (e.g., “yes”) in order to verify the number is to be used in association with the account.

If the mobile phone number is verified, user interfaces, some of which are further described below, may be provided and accessed by the user via which the user may enter user information, such as a name (the first name may be required and the second name may be optional), birthdate, age, zodiac sign, gender (e.g., man, woman, transman, transwoman, etc.), gender preference for potential matches (men, women, transmen, transwomen, any gender), ask me about topics, photographs, height, color hair, color eyes, gender, religion, other affiliations, lifestyle choices, interests, and/or other information. Optionally, controls may be provided in association with one or more items of profile information (e.g., birth date, zodiac sign, gender, gender preferences, and/or other information) via which the user can instruct that the item of profile information is not to be displayed to other users (e.g., in profile information displayed to other users).

Optionally, certain user-provided information may disqualify the user from establishing an account and/or utilizing a service. For example, the user's age may be determined from the birthdate entered by the user. If the user's age is determined to be less than an age threshold (e.g., 18, 21, 28, etc.) the user may be prevented from establishing an account and/or using the matching and/or communication services described herein.

FIG. 5B illustrates an example user interface via which a user may submit photographs to be uploaded to the system and user as profile photographs. The user may be required to provide a minimum number of photographs (e.g., 1, 2, or 3 photographs) and may inhibit the user from providing more than a maximum number of photographs (e.g., 4, 5, or 6 photographs). The user interface may provide a control that enables a user to select a photograph from a user's photograph gallery stored on the user's device or elsewhere, from another social networking account of the user, and/or a control that enables the user to take a new photograph using a camera included in the user's device (e.g., mobile phone).

The user interface may display the uploaded photographs as thumbnails. The user interface may enable the user to drag (e.g., using a finger or other pointing device) a thumbnail of the uploaded photographs from one position to another position. The photographs may be displayed in the user's profile and/or to other users in the order arranged by the user. Optionally, the photograph in the first row, first column position will be used as the main profile image, but potential matching users may be enabled to swipe through to view the other photographs, or the other photographs may be displayed at the same time to the potential matching users. Optionally, the user may be prevented from navigating to the next user interface and/or from using the matching and/or communication services provided by the system until the user provides the minimum number of required photographs.

FIG. 5C illustrates an example user interface via which a registering user may select topics that are of interest to the registering user and that the registering user wants potential matching user to ask the registering user about (e.g., “ask me about:” “my dog”, “my idea of a perfect date”, “my bucket list”, “my absolute dream job”, etc.) as conversation starters or throughout a conversation with a potential matching user. The topics may be selected from a set of topics. Controls may be provided via which the registering user may customize a given topic. In addition, a control may be provided via which the registering user may create their own topic. Optionally the registering user may be limited to a certain number of topics (e.g., 3 topics, 5 topics, 7 topics, etc.). Optionally, the user may be prevented from navigating to the next user interface and/or from using the matching and/or communication services provided by the system until the user has selected a minimum threshold number of topics (e.g., 1 topic, 2 topics, 3 topics, etc.).

Once the user has completed the onboarding process by providing the requested photographs and requested information, the user may be notified that the onboarding process is complete. Optionally, the now registered user (who may be referred to as the requesting user) may be automatically navigated to a browsing user interface via which the requesting user can view potential matches (e.g., where the user interface may display a profile image of another user, a name of the user, the age of the user, a conversation started topic specified by the user).

As similarly discussed elsewhere herein, potential matches may be selected based on the requesting user's profile and preferences, and/or based on based on the profile and preferences of other users. In addition, certain other users may be excluded from being included in the potential matches, such as other users that have blocked the requesting user, that have unmatched the requesting user, or that have reported the requesting user.

FIG. 5D(1) illustrates an example user interface displaying a potential match. In this example, the user interface displays a first name of the potential match, the potential match's age, a conversation starting topic specified by the potential match, a no interest control (e.g., a “BYE” waving hand control) and a like control (e.g., a “HI” waving hand control). Optionally, other profile data of a potential match may be presented, such as interests, affiliations, life style, etc.

The requesting user may select (e.g., by tapping a “BYE” control) to indicate no interest in the potential match. If the requesting user indicates a lack of interest, the potential match may be excluded from being selecting as a potential match for the requesting user in the future (e.g., for an extended period of time, such as several months (for example, but not limited to, 6 months) to 2 years, or without being limited to a finite time period). The next potential match (and related images and profile data) may be displayed to the requesting user.

If instead, the requesting user selected the checkmark, indicating that the requesting user is interested in the potential match, a corresponding like indication may be stored in system and/or device memory. The potential match may be added to a list of liked potential matches.

The user interface illustrated in FIG. 5D(1) may include navigation controls (e.g., in a footer area towards the bottom of the user interface) via which the requesting user may access other user interfaces and functions (e.g., a matches user interface listing matches, a likes user interface listing liked users, an account user interface, and a help and feedback user interface). The navigation controls may be dynamically modified to include different navigation controls based on the user interface currently being accessed (e.g., the navigation controls may exclude a link to the currently displayed user interface). Some or all of the user interfaces described herein may include the same of similar navigation controls (e.g., in a footer area).

If the potential match likes the requesting user back, a notification may be provided to the requesting user, as illustrated in FIG. 5D(2). Optionally, the application notification is only presented if the user is logged in, the application is active, and an application user interface is displayed. Optionally, to reduce the amount of navigation and system interaction, a match may be made on the spot if the user who has already said “Hi” is displayed in the user interface (e.g., a “Graze” navigation control). If such match is made, a match notification may be presented (e.g., a voice and/or an “It's a match” pop-up or slider notification user interface such as that illustrated in FIG. 5D(3)). Optionally, a user can prohibit or enable the like and/or other such notifications via an account setting as discussed elsewhere herein. In this example, the notification is displayed overlaying the user interface that was being displayed to the user.

If the user selects the like notification (e.g., by tapping on the like notification) a determination may be made as to whether the user receiving the notification had previously liked the user that is the source of the like notification. In response to determining that the user receiving the notification had not previously liked the user that is the source of the like notification, the user may be navigated to a user interface (e.g., a says “Hi” to you or “likes you” user interface), an example of which is illustrated in FIG. 5E.

As illustrated in FIG. 5E a list of other users that have liked the present user may be listed, with respective images, names, ages, the dates they submitted the like indication, and a corresponding like control (a checkmark) and a not interested control (an “X” or “Bye” waving hand control). The present user may selectively activate the like control or provide a not interested indication by activating the not interested control for each of the listed users. Alternatively, the present user may take no action, and the users may remain included in the list of other users that have liked the present user.

If the present user activates the like control, the corresponding user may be so notified and a match indication may be stored and displayed. If the user activated the not interested control, the corresponding user may optionally be so notified, and the corresponding user's entry may be removed from the list of other users that have liked the present user.

If the potential match user likes the requesting user back, a match notification may be provided to the requesting user as illustrated in FIG. 5F (e.g., as a popup or slider user interface). Optionally, the application match notification is only presented if the user is logged in, the application is active, and an application user interface is displayed. Optionally, a user can prohibit or enable like and/or other such notifications via an account setting. In this example, the match notification is displayed overlaying the user interface that was being displayed to the user.

A user may view the user's matches by accessing a match navigation control interface. Referring to FIG. 5G, the match user interface may render a list of other users that have matched the present user, with respective photographs, names, ages (if permitted by the matching user), and the dates they matched the present user.

In addition, an indication may be provided (e.g., an icon, checkmark or other mark adjacent to or overlaying the matching user photograph) for each listed matching user as to whether the corresponding listed matching user completed the verification video discussed above. The indication that a given matching user completed the verification video further indicates that the matching user is enabled to conduct first communication via a first communication channel (e.g., a video call) which, as mentioned above, can in some but not all embodiments be required before a second or subsequent communication channel is enabled or available to the user. Optionally, as similarly discussed above, even if the user has not completed the video verification, the user may still be enabled to conduct the first communication via a communication channel (e.g., a video call).

A video communication initiation control may be presented in association with an entry for a matching user that has completed the verification video. Activation of the video communication control initiates a video call with the corresponding matching user. Optionally, if the matching user has not completed the verification video, the corresponding video communication initiation control may be disabled (optionally with a visual indication that the video communication initiation control is disabled) or not displayed. Optionally instead, even if the matching user has not completed the verification video, the corresponding video communication initiation control may be displayed and enabled. A quick message user interface may be provided comprising a preset menu of messages from which a user may select and transmit to the other user. Optionally, a user interface may be provided enabling a user to transmit a video chat communication invitation including scheduling data for the first video communication session/date (e.g., a video chat invitation including a date and time). The receiving user may, via corresponding controls, such as those illustrated in FIG. 5V, accept the invitation and add the invitation to their calendar, propose an alternative date/time, or cancel the video chat communication/date. The invitation may include a description (e.g., video chat communication session with [name of matching user]), a start time, and end time (which may be set to a short period of time, such as between 3-10 minutes, such as 6 minutes).

In addition, a chat communication control may be provided that enables the user to initiate a text chat with the corresponding matching user. Optionally, the chat initiation control is only presented and/or enabled after the user has completed a video communication with the matching user, and neither user had, after the video communication, activated an unmatch control, a block control, and/or reported the other user.

Once a video chat communication session invitation is issued, the chat session may be added to an “upcoming video chat communication sessions” user interface. The chat session entry may include the name of the other user that will be participating in the chat, the chat date and time, and the status (e.g., waiting for your match to confirm, chat invitation accepted, etc.).

If the user does not initiate a video call for a specified threshold period of time (e.g., 2 hours, 12 hours, 2 days, etc.) as tracked by the user device or system, a prompt notification may be automatically generated and presented to the user. The prompt notification may indicate how long it has been since the match occurred and/or the date/time of the match, and may prompt the user to initiate a video call with the corresponding matching user (e.g., by displaying a “Make a Move” banner or by other markings, next to the corresponding matching user entry).

In addition, a control may be provided that enables a user to transmit a pre-specified text or graphic communication (which may be referred to as a quick message) to a matching user (e.g., “schedule video chat communication session,” “give me a ring,” “sorry, can't chat right now,” “call you later,”, “let's chat after you activate your facial image verification/catfish catcher). Optionally, only one quick message may be sent at a time. Optionally, the user may be inhibited from transmitting a free form text message to the other user prior to the initial video chat communication.

The match user interface may include a do not disturb or away control (e.g., a toggle control), which when activated causes an indication to be provided on the match user interface of matching users that the user is currently unavailable for a video call. For example, the “Do Not Disturb” indication may be in the form of an icon (e.g., a half-moon icon) in the corresponding user entry in the match user interface.

The match user interface may include navigation controls (e.g., in a footer area towards the bottom of the user interface) via which the requesting user may access other user interfaces and functions (e.g., a browser user interface displaying a potential match, a likes user interface listing liked users, an account user interface, and a help and feedback user interface).

Optionally, a notification may be displayed over the match user interface (or other active user interfaces described herein when the user is logged in) prompting the user to record a verification video. The user may then record the verification user interface as described elsewhere herein.

FIG. 5H(1) illustrates an example initial account user interface, including a user name, a control to access a profile edit user interface via which the user can edit the user's profile, a link to the user's preferences, a link to account settings, and a link to a help user interface.

FIG. 5H(2) illustrates an example interface displaying profile images of the user. The user interface can be configured to enable the user to drag and drop images to a desired order (where the image in the first row and first column may be the initial image displayed in a match entry displayed to other users). The user may be required to provide a specified number of photographs, (e.g., a minimum of two and a maximum of ten), where if the user does not provide the minimum number of images, the user may be inhibited from using the services herein to conduct video chat communication sessions.

FIG. 5H(3) illustrates example conversation starter topics and text for the user in association with edit controls which when activated enables the user to edit the topics. An Interests user interface displays previously identified interests of the user (which may be displayed to other users, such as potential matches, and/or which may be used in performing matches), in association with controls via which the user can add or delete interests.

A basic user information user interface may include interface configured to receive from the user (e.g., name, gender, age, zodiac, height, ethnicity, current number of children, family planning (e.g., wants children, does not want children), and/or the like). Controls may be provided via which the user may set visibility settings to control what profile data will and will not be displayed to other users (e.g., potential matching users).

FIG. 51 illustrates an example account user interface via which the user can set visibility settings with respect to affiliations (e.g., school, education level, work, job title, religion, political views, hometown, and/or the like), lifestyle (drinking, smoking, marijuana, drugs, and/or the like), and/or other profile information. Via the user interface, the user can control what profile information may be provided to other users (e.g., via the match user interface or other user interfaces).

As discussed above, a facial image verification process (which may be referred to as a “catfish catcher”) may optionally be performed. FIG. 5J illustrates an example verification video interface comprising user instructions and a text script to be recited by the user when recording the verification video (e.g., step 1, record; step 2 “Say, my name is . . . ”; step 3 review recording or re-record another verification video). A record control may be provided which when activated causes the user device camera and microphone to record a video (including an audio track) of the user reciting the text.

FIG. 5K illustrates an example verification video recording user interface at different stages. FIG. 5K(1) illustrates a verification video countdown timer, configured to prepare the user to record the user reciting the script, a record initiation control, and a video recording process cancellation control.

Referring to FIG. 5K(2), after the recording is initiated, a recording countdown time is displayed, indicating how long the user has to finish recording the verification video (e.g., beginning at 3 seconds). In addition, an alignment indicator may be provided (e.g., a square, rectangular, oval, or circular shape) indicating where the user's face should appear in the “view finder”. The image captured by the user device camera (e.g., the front facing camera of a mobile phone or tablet, or the webcam of a desktop or laptop computer) may be displayed. The record control may be surrounded by a progress ring that is dynamically extended/filled in as the recording progress and the countdown timer counts down.

Referring to FIG. 5K(3), once the recording is completed (and stored on the user device), a verification video completed interface is rendered. A control (“Record New”) is provided via which the user may initiate a new recording (which may cause the current recording to be automatically deleted so as to utilize less memory resources). An approve control (e.g., a checkmark) is provided which when activated approves use of the current recorded verification video and the recorded video may be uploaded from the user device to the remote system. The video may be assigned to a position (e.g., a specific position) or location in the user's profile. Once the image is uploaded an upload confirmation indication (e.g., a blue checkmark or other marking) may be displayed overlying or close to the user's main profile image. The user may now be enabled to initiate and/or receive video calls with matching users.

Referring to FIG. 5L(1), if a video call is initiated, a call pending notification may be presented on the user interface. A cancel control may be provided via which the user can cancel an outgoing video call. Within a certain period of time (e.g., 3 seconds, 5 seconds, or 10 seconds) prior to the video call participants being connected, a countdown timer may be presented (as illustrated in FIG. 5L(2)). Optionally, selected portions of a call participant's profile data may be presented on the device of the other call participant in accordance with sharing permissions. For example, a participant's first name, age, profile image(s), Ask Me About conversation starters and/or other profile data may be displayed during the countdown period, until the video call connection is made so that the participants may conduct the call. A call termination control (e.g., in the form of a hang up icon) may be displayed enabling a participant to terminate the call when so desired.

As illustrated in FIG. 5M, an example incoming call notification is presented that identifies the incoming caller (e.g., by the caller's first name or alias). The notification may overlay the Ask Me about conversation starter topics. If the receiving user taps on the notification (or otherwise provides a call acceptance instruction), the inbound video call is accepted and the live video call may commence. A no interest control (e.g., a “BYE” waving hand control) and a like control (e.g., a “HI” waving hand control) may be provided via which the user can indicate that the user is not or is interested in the other user.

FIG. 5N(1) illustrates an example live streaming video call user interface displayed on a user device. The example user interface may display the other call participant in substantially all of the user interface (in full screen mode), and a picture-in-picture floated pane may be provided that renders a live view of the device user. As discussed elsewhere herein, the video call may be limited to a maximum period of time (e.g., 3 minutes, 5 minutes, 7 minutes, etc.). A countdown timer may be provided showing the remaining time left in the call. A control may be provided that when activated causes profile information (e.g., profile images, ask me about topics, etc.) of the other call participant to be displayed as an overlay as illustrated in FIG. 5N(2). End call, mute, and flip controls may also be provided. Activation of the flip control may exchange the video feeds for the main video display area and the picture in a picture pane. Referring again to FIG. 5N(2), a control may be provided (an “X” icon) that when activated causes the profile information overlying the live video feed to be removed.

When the maximum call period has expired, a time's up notification may be presented to the user as illustrated in FIG. 50(1), with the countdown timer displaying the time expiration (e.g., 0 seconds), thereby notifying the user that the video call has ended. An opaque overlay may be displayed over a fixed image of the user and/or of the other call participant to graphically emphasize that the video call has ended.

FIG. 50(2) illustrates an example feedback user interface which may be automatically displayed in response to detecting that the video call has been terminated (e.g., terminated by either of the call participants or automatically terminated in response to detecting that the maximum call duration has been reached). The feedback user interface may be caused to be displayed on the devices of both call participants at the same time. Each user/call participant may need to take an action via a control provided by the feedback user interface, such as chat (by activating/tapping a chat graphic control), stay matched (by activating/tapping a stay matched control), block (by activating/tapping a block graphic control), unmatch (e.g., by activating/tapping a “BYE” waving hand control), or report (by activating/tapping a report graphic control).

If a call participant activates the chat control, a chat interface may be presented, an example of which is illustrated in FIG. 5P, so that the call participant may conduct a text chat with the other call participant.

If the call participant activates the stay matched control, a corresponding stay matched indication may be stored in memory and the user may be navigated back to the matches user interface. If a call participant activates the block control, a block user interface may be presented (an example of which is described herein), and the other call participant may be inhibited from contacting the participant (e.g., via a chat or video communication), and the other call participant may be removed from the participant's match list. If a call participant activates the unmatch control, the other call participant may be removed from the participant's match list and, optionally, may be inhibited from contacting the participant (e.g., via a chat or video communication). If a call participant activates the report control, a report user interface may be displayed via which the call participant may enter a report on the other call participant (as discussed elsewhere herein) the other call participant may be inhibited from contacting the participant (e.g., via a chat or video communication), and the other call participant may be removed from the participant's match list.

Referring to FIG. 5P, an example chat user interface is illustrated displaying a text message thread between two users that had conducted a video call. Optionally, a user is restricted from accessing and/or utilizing the chat user interface to chat with another user until the user has engaged in a video call with the other user after the two users have been matched. A user may not be required to respond to a chat text. Optionally, the system generates an initial chat entry including the name of the other user who participated in the video call (e.g., “You and Payton had a video call date”). To efficiently display profile information of the other chat participant at the same time as the chat interface and controls, the user interface may be split by horizontal slider, enabling a user to easily and quickly shift from utilizing the chat function to viewing the profile of the other chat participant. A dropdown menu interface is provided (e.g., a three dot menu via which the user may block the other user, unmatch the other user, or report the other user).

FIG. 5Q(1) illustrates an example unmatch user interface. A popup interface may be presented via which the user/call participant can confirm or cancel an unmatch request. If the user/call participant confirms the unmatch request, the other call participant may be removed from the user's match list, the other call participant's match list, and/or the other call participant may be inhibited from contacting the user/call participant (e.g., via a chat or video communication). A dropdown menu interface is provided (e.g., a three dot menu via which the user may block the other user, unmatch the other user, report the other user, or cancel).

FIG. 5Q(2) illustrates an example block match user interface. A popup interface may be presented via which the user/call participant can confirm or cancel a block request. If the user/call participant confirms the block request, the other call participant may be removed from the user's match list, the other call participant's match list, and/or the other call participant may be inhibited from contacting the user/call participant (e.g., via a chat or video communication). A dropdown menu interface is provided (e.g., a three dot menu via which the user may block the other user, block the other user or another user, report the other user, or cancel).

FIG. 5Q(3) illustrates an example report user interface that may be presented in respond to an activation of a report menu entry, such as described above. The report user interface includes predefined reasons for which the user/call participant can select indicating why the other call participant is being reported (e.g., threats/harassment, nudity/sexual, underage, hate speech, spam, other, etc.). In addition, a free form text field may be provided via which the user can textually enter details on the facts and reasons the user/call participant is reporting the other call participant. The other call participant may be inhibited from viewing the user/call participant entries and the system may inhibit providing a notification to the other call participant regarding the report. A submit control is provided which when activated will cause the user entries/selections to be uploaded to the system and stored in the user/call participant's database records and/or the other call participant's database records. A cancel control is provided via which the user/call participant may cancel submission of the report. A dropdown menu interface is provided (e.g., a three dot menu via which the user may report the other user, report the other user or another user, report the other user, or cancel).

FIG. 5R illustrates example account user interfaces which may be accessed via an account menu interface. A preferences user interface, as illustrated in FIG. 5R(1), may enable a user to enter (or view preferences previously entered) the user's set location (e.g., state, city, and/or zip code), a maximum distance from the user's location for potential matches, type of match the user is interested in (e.g., gender), and age range the user is interested in. The preferences may be used in identifying and displaying potential matching users to the user as described elsewhere herein.

If the user selects the location entry for editing via the user interface of FIG. 5R(1), the example user interface illustrated in FIG. 5R(2) may be displayed. As the user incrementally enters the user's location in a location field, a database search of locations may be incrementally performed and locations matching the current sequence of letters entered into the user location field may be displayed. The user may select from among the displayed locations, thereby speeding the location entry process and reducing typographical errors. Controls are provided to save the user's edits or to cancel the user's edits.

If the user selects the distance entry for editing via the user interface of FIG. 5R(1), the example user interface illustrated in FIG. 5R(3) may be displayed. The user interface enables the user to drag a distance icon/tab linearly (e.g., by tapping on the icon with a finger and moving the finger rightward). As the user drags the distance icon, the user interface may be automatically updated to textually display the corresponding distance. Controls are provided to save the user's edits or to cancel the user's edits.

If the user selects the type of match the user is interested in entry for editing via the user interface of FIG. 5R(1), the example user interface illustrated in FIG. 5S(1) may be displayed. The user interface enables the user to specify the gender(s) that the user is interested in (e.g., men, women, everyone, etc.) with respect to potential matches. Controls are provided to save the user's edits or to cancel the user's edits.

If the user selects the age range entry for editing via the user interface of FIG. 5R(1), the example user interface illustrated in FIG. 5S(2) may be displayed. The user interface enables the user to drag age icon/tabs linearly (e.g., by tapping on the icon with a finger and moving the finger leftward or rightward) to set a minimum age and a maximum age respectively. As the user drags an age icon, the user interface may be automatically updated to textually display the corresponding age. Controls are provided to save the user's edits or to cancel the user's edits.

FIG. 5T(1) illustrates an example settings user interface via which the user may enter such user settings as phone number, email address, push notifications, and do not disturb on/off (to prevent notifications may being displayed and/or audible notification alerts from being played by the user device). Controls may be provided via which the user may selectively link other social networking accounts to their account. In addition, links may be provided to certain online documents. A control may be provided enabling the user to sign out of the user's account. A delete account control is provided enabling the user to delete the user's account.

In response to the user selecting the push notification entry illustrated in FIG. 5T(1), the push notification user interface illustrated in FIG. 5T(2) may be displayed. Controls are provided via which the user can turn on and off different types of notifications, such as new “likes” from other users notifications, new matches detected notifications, new messages received notifications, incoming video call notifications, and/or a new match available notifications.

Thus methods and systems are described that enable multi-modal communication among disparate, heterogeneous devices, where, optionally, different modes of communications are performed in a specified sequence according to certain rules. In addition, systems and methods are described that enable user verification using video and other techniques. Still additional aspects relate to ensuring that computer resources are not unduly used by stale data and accounts.

### Terminology

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces. Optionally, brain-computer or neural interfaces may be used to interact with and control the system and interactive environments.

Further, processing of the various components of the illustrated systems can be distributed across multiple machines, networks, and other computing resources, or may comprise a standalone system. Two or more components of a system can be combined into fewer components. Various components of the illustrated systems can be implemented in one or more virtual machines, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone application, computer application, a short messaging service message (e.g., SMS, MMS, etc.), instant messaging, email, push notification, audibly, and/or otherwise.

The user terminals (e.g., end user devices, administrator devices, etc.) described herein may be in the form of a mobile communication device (e.g., a cell phone), laptop, tablet computer, interactive television, game console, media streaming device, AR/VR head-wearable display, networked watch, etc. The user terminals may optionally include displays, speakers, haptic output devices, user input devices (e.g., touchscreen, keyboard, mouse, microphones, voice recognition, etc.), network interfaces, etc. Which enables corresponding location-based content and feedback (visual (e.g., 2D, AR, VR content), audio, and/or haptic content and feedback) to be provided to the user.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. Any claims intended to be treated under 35 U.S.C. §112(f) will begin with the words “means for,” but use of the term “for” in any other context is not intended to invoke treatment under 35 U.S.C. §112(f). Accordingly, the applicant reserves the right to pursue additional claims after filing this application, in either this application or in a continuing application.

What is claimed is:

1. A multi-modal communication system, the multi-modal communication system comprising:
one or more processing devices;
a network interface;
non-transitory memory that stores instructions that when executed by the one or more processing devices are configured to cause the computer system to perform operations comprising:
receiving, via the network interface, a message from a first user device automatically transmitted by an application hosted on the first user device;
based at least in part on the received message, identifying a record associated with a first user;
using the record associated with the first user and records of a first plurality of other users, identifying a subset of users in the first plurality of other users;
ranking the subset of users;
using the ranking of the subset of users, selecting from the subset of users a second user;
selecting a portion of data in a record associated with the second user, wherein the selecting is based at least in part on one or more rules specified by the second user;
transmitting the selected portion of data to the application hosted on the first user device, where the application renders some or all of the selected portion of data;
receiving a communication request from the application hosted on the first user device;
at least partly in response to receiving the communication request from the application hosted on the first user device, enabling the first user to communicate with the second user using a first mode of communication, wherein the communication using the first mode of communication is limited to a predetermined maximum time length;
determining that the predetermined maximum time length has been reached;
terminating the communication using the first mode of communication at least partly in response to determining that the predetermined maximum time length has been reached; and
after terminating the communication using the first mode of communication, enabling the first user to utilize the second mode of a plurality of modes of communications to communicate with the second user.

2. The multi-modal communication system as defined in claim 1, the operations further comprising:
transmitting a request to a third user device for a verification video;
receiving the verification video;
analyzing the received verification video; and
at least partly in response to the analysis of the received verification video, enabling the first mode of the plurality of modes of communications between the third user and another user, wherein at least the second mode of the plurality of modes of communications is disabled.

3. The multi-modal communication system as defined in any of the previous claims, the operations further comprising:
using a neural network comprising an input layer, a plurality of hidden layers and an output layer to detect a first type of speech inflection of a third user in a verification video received from the third user; and
at least partly in response to detecting a first type of speech inflection of the third user in the verification video received from the third user, inhibiting the third user from accessing one or more services of the multi-modal communication system.

4. The multi-modal communication system as defined in any of the previous claims, the operations further comprising:
receiving a verification video from the first user device;
enabling the received verification video to be analyzed;
at least partly in response to the analysis of the received verification video, providing a verification indication in association with information regarding the first user to the second user.

5. The multi-modal communication system as defined in any of the previous claims, the operations further comprising:
receiving a verification video from the first user;
analyzing the received verification video from the first user to detect a facial image;
receiving a still photograph from the first user, the still image including a facial image;
detecting the facial image in the still photograph;
detecting a facial image in the verification video;
using a neural network comprising an input layer, a plurality of hidden layers and an output layer to determine if the facial image in the still photograph is of a same person as the detected facial image in the verification video; and
at least partly in response to determining that the detected facial image in the still photograph is of a same person as the detected facial image in the verification video, enabling the first user to access one or more services of the multi-modal communication system and/or providing a verification indication regarding the first user to one or more other users.

6. The multi-modal communication system as defined in any of the previous claims, the operations further comprising:
receiving a blocking message with respect to the second user from the application hosted on the first user device, wherein the application hosted on the first user device automatically presents a block control after the communication using the first mode of communication is terminated; and
at least partly in response from receiving the blocking message with respect to the second user from the application hosted on the first user device, inhibiting the second user from using the first mode communication and the second mode of communication to communicate with the first user.

7. The multi-modal communication system as defined in any of the previous claims, the operations further comprising:
providing images of users in the subset of users to the first user device, wherein a user interface displayed on the first user device enables the first user to swipe through the images using a touch gesture.

8. The multi-modal communication system as defined in any of the previous claims, the operations further comprising:
displaying profile content of users in the subset of users one at a time on the first user device, wherein a user interface displayed on the first user device enables the first user to scroll through the profile content of users.

9. The multi-modal communication system as defined in any of the previous claims, wherein the system is configured such that a given user in the subset of users is required to input conversation starter questions about the given user into his or her profile content, and wherein the conversation starter questions are included in the profile content displayed on the first user device.

10. The multi-modal communication system as defined in any of the previous claims, wherein the first mode of communication comprises a video call and conversation starter questions input by the second user are presented on the first user device during the video call.

11. The multi-modal communication system as defined in any of the previous claims, wherein the system is configured such that the first mode of communication must be completed before any other mode of communication is enabled.

12. The multi-modal communication system as defined in any of the previous claims, wherein the first mode of communication comprises a video call and the second mode of communication comprises text messaging.

13. The multi-modal communication system as defined in claim 12, wherein the first mode of communication comprises a video call and wherein the system is configured such that the video call must be completed before the second mode of communication is enabled.

14. A computer-implemented method comprising:
receiving, at a computer system comprising one or more computing devices, a message from a first user device transmitted by an application hosted on the first user device;
based at least in part on the received message, identifying, using the computer system, a record associated with a first user;
using the record associated with the first user and records of a first plurality of other users, identifying, using the computer system, a subset of users in the first plurality of other users;
selecting, using the computer system, from the subset of users a second user;
accessing, using the computer system, a portion of data in a record associated with the second user;
transmitting, using the computer system, the accessed portion of data over a network to the application hosted on the first user device, where the application renders some or all of the accessed portion of data;
receiving, using the computer system, a communication request from the application hosted on the first user device;
at least partly in response to receiving the communication request from the application hosted on the first user device, enabling the first user to communicate with the second user using a first mode of communication, wherein the communication using the first mode of communication is limited to a predetermined maximum time length;
determining that the predetermined maximum time length has been reached,
wherein the communication using the first mode of communication is terminated at least partly in response to determining that the predetermined maximum time length has been reached and the first user is inhibited from using a second mode of communication to communicate with the second user prior to the communication using the first mode of communication; and
after the communication using the first mode of communication is terminated, enabling the first user to utilize the second mode of the plurality of modes of communications to communicate with the second user.

15. The method as defined in claim 14, the method further comprising:
receiving a verification video from the first user device;
enabling the received verification video to be analyzed;
at least partly in response to the analysis of the received verification video, providing a verification indication in association with information regarding the first user to the second user.

16. The method as defined in any one of claims 14-15, the method further comprising:
receiving a verification video from the first user device;
detecting a facial image in the verification video;
receiving a still photograph from the first user, the still image including a facial image;
detecting the facial image in the still photograph;
detecting a facial image in the verification video;
using a neural network comprising an input layer, a plurality of hidden layers and an output layer to determine if the facial image in the still photograph is of a same person as the detected facial image in the verification video; and
at least partly in response to determining that the detected facial image in the still photograph is of a same person as the detected facial image in the verification video, enabling the first user to access one or more services of the multi-modal communication system and/or providing a verification indication regarding the first user to one or more other users.

17. The method as defined in any one of claims 14-16, the method further comprising:
receiving a blocking message with respect to the second user from the application hosted on the first user device, wherein the application hosted on the first user device automatically presents a block control after the communication using the first mode of communication is terminated; and
at least partly in response from receiving the blocking message with respect to the second user from the application hosted on the first user device, inhibiting the second user from using the first mode communication and the second mode of communication to communicate with the first user.

18. The method as defined in any one of claims 14-17, the method further comprising:
providing images of users in the subset of users to the first user device, wherein a user interface displayed on the first user device enables the first user to swipe through the images using a touch gesture.

19. The method as defined in any one of claims 14-18, the method further comprising:
providing profile content of users in the subset of users to the first user device, wherein a user interface displayed on the first user device enables the first user to scroll through the profile content of users.

20. The method as defined in any one of claims 14-19, the method further comprising requiring a given user in the subset of users to input conversation starter questions about the given user into his or her profile content, and wherein the conversation starter questions are included in profile content displayed on the first user device.

21. The method as defined in any one of claims 14-20, wherein the first mode of communication comprises a video call and conversation starter questions input by the second user are presented on the first user device during the video call.

22. The method as defined in any one of claims 14-21, wherein the first mode of communication comprises a video call and the second mode of communication comprises text messaging.
